(19) United States
(12) Patent Application Publication
(10) Pub. No.: US 2012/0223579 A1
(43) Pub. Date: Sep. 6, 2012

(54) ELECTRICAL CHARGING AND DISCHARGING SYSTEM AND CHARGE AND DISCHARGE CONTROL DEVICE

(75) Inventors: Souichi SAKAI, Moriguchi-shi (JP); Takeshi Nakashima, Moriguchi-shi (JP)

(73) Assignee: SANYO ELECTRIC CO., LTD., Moriguchi-shi (JP)

(21) Appl. No.: 13/414,888

(22) Filed: Mar. 8, 2012

Related U.S. Application Data
(63) Continuation of application No. PCT/JP2011/050949, filed on Jan. 20, 2011.

(30) Foreign Application Priority Data
Jan. 20, 2010 (JP) 2010-010272

(51) Int. Cl. H02J 3/32

(52) U.S. Cl. 307/48

(57) ABSTRACT

The electric power generation system has a power generator configured to generate electric power using renewable energy, a battery configured to store electric power generated by the power generator, a detector configured to detect regularly a power data that is the amount of electric power generated by the power generator, a power output means configured to output electric power generated by the power generator and electric power discharged by the battery, and a controller configured to control the charge and discharge of the battery. The controller is configured to acquire the power data from the detector, to determine a first period based on the size of the fluctuations in the amount of electric power generated by the power generator from a first generated power output to a second generated power output, to control the charge and discharge of the battery.

This application is a continuation of International Application No. PCT/JP2011/050949, filed Jan. 20, 2011, which claims priority from Japanese Patent Application No. 2010-010272, filed Jan. 20, 2010, the entire contents of which are incorporated herein by reference.

### FIELD OF INDUSTRIAL USE

The present invention relates to an electrical charging and discharging system and a charge and discharge control device, in particular, to a charging and discharging system and a charge and discharge control device provided with a power storage means capable of storing the power generated by a power generating device using natural energy.

### PRIOR ART

In recent years, the number of instances where power generators utilizing natural energy such as wind power or sunlight are connected to consumer homes in receipt of a supply of alternating power from an electricity substation has increased. These types of power generators are connected to the power grid subordinated to the substation, and power generated by the power generators is output to the power consuming devices side of the consumer location. Moreover, the superfluous electric power, which is not consumed by the power consuming devices in the consumer location, is output to the power grid. The flow of this power towards the power grid from the consumer location is termed “counter-current flow”, and the power output from the consumer to the electric grid is termed “counter-current power”.

In this situation, the power suppliers such as the power companies and the like have a duty to ensure the stable supply of electric power and need to maintain the stability of the frequency and voltage of the overall power grid, including the counter-current power components. For example, the power supply companies maintain the stability of the frequency of the overall power grid by a variety of methods in correspondence with the size of the fluctuation period.

Specifically, in general, in respect of a load component with a fluctuation period of some tens of minutes, economic dispatching control (EDC) is performed to enable output sharing of the power output in the most economic manner. This EDC is controlled based on the daily load fluctuation expectation, and it is difficult to respond to the increases and decreases in the load fluctuation from minute to minute and second to second (the components of the fluctuation period which are less than some tens of minutes). In that instance, the power companies adjust the amount of power supplied to the power grid in correspondence with the minute fluctuations in the load, and perform plural controls in order to stabilize the frequency. Other than the EDC, these controls are called frequency controls, in particular, and the adjustments of the load fluctuation components not enabled by the adjustments of the EDC are enabled by these frequency controls.

More specifically, for the components with a fluctuation period of less than approximately 10 seconds, their absorption is enabled naturally by the endogenous control functions of the power grid itself.

Moreover, for the components with a fluctuation period of about 10 seconds to the order of several minutes, they can be dealt with by the governor-free operation of the generators in each generating station.

Furthermore, for the components with a fluctuation period of the order of several minutes to tens of minutes, they can be dealt-with by load frequency control (LFC). In this load frequency control, the frequency control is performed by the adjustment of the power output of the generating station for LFC by a control signal from the central power supply command station of the power supplier.

However, the output of power generators utilizing natural energy may vary abruptly in correspondence with the weather and such like. This abrupt fluctuation in the power output of this type of power generator applies a gross adverse impact on the degree of stability of the frequency of the power grid they are connected to. This adverse impact becomes more pronounced as the number of consumers with generators using natural energy increases. As a result, in the event that the number of consumers with electricity generators utilizing natural energy increases even further henceforth, there will be a need arising for sustenance of the stability of the power grid by the control of the abrupt fluctuation in the output of the generators.

In relation to that, there have been proposals, conventionally, to provide power generation systems with batteries to enable the storage of electricity resulting from the power output by power generators, in addition to the power generators utilizing natural energy, in order to control the abrupt fluctuation in the power output of these types of generators. Such a power generation system was disclosed, for example, in Japanese laid-open patent publication No. 2001-5543.

In the Japanese laid-open published patent specification 2001-5543 described above, there is the disclosure of a power system provided with solar cells, and invertors which are connected to both the solar cells and the power grid, and a battery which is connected to a bus which is also connected to the inverter and the solar cells. This power generation system, by performing the charging and discharging of the battery following the fluctuations in the power output (output) from the solar cells, suppresses the fluctuations in the power output from the inverter. By these means, because the fluctuations in the power output to the power grid are suppressed, the suppression of adverse effects on the frequency of the power grid is enabled.

### PRIOR ART REFERENCES

### Patent References

Patent Reference #1: Japanese laid-open published patent specification 2001-5543

### OUTLINE OF THE INVENTION

### Problems to be Solved by the Invention

However, in this power generation system, because the charging and discharging of the battery following the fluctuations in the power output of the power generator is performed on every such instance, the number of instances of charging and discharging are great, and as a result, there is the problem that the lifetime of the battery is reduced.

This invention was conceived of to resolve the type of problems described above, and one object of this invention is the provision of a charge and discharge system and a charge and discharge control device which contrive to enable a longer lifetime for the battery while suppressing the effects on the power grid caused by the fluctuations in the power output of the power generator.

### SUMMARY OF THE INVENTION

The electric power generation system, comprising: a power generator configured to generate electric power using renewable energy; a battery configured to store electric power generated by the power generator; a detector configured to detect regularly a power data that is the amount of electric power generated by the power generator; a power output means configured to output electric power generated by the power generator and electric power discharged by the battery; and a controller configured to control the charge and discharge of the battery, wherein the controller is configured to acquire the power data from the detector, to determine a first period based on the size of the fluctuations in the amount of electric power generated by the power generator from a first generated power output to a second generated power output, to control the charge and discharge of the battery when the amount of electric power generated by the power generator does not return to within a specific range from the first generated power output during from an point in time to the first period, the point in time is time that the amount of electric power generated by the power generator fluctuates from a first generated power output to a second generated power output.

The method of controlling a battery storing electric power generated by a power generator generating electric power using renewable energy, comprising: detecting regularly a power data that is the amount of electric power generated by the power generator; acquiring the power data from the detector; determining a first period based on the size of the fluctuations in the amount of electric power generated by the power generator from a first generated power output to a second generated power output; controlling the charge and discharge of the battery when the amount of electric power generated by the power generator does not return to within a specific range from the first generated power output during from an point in time to the first period, the point in time is time that the amount of electric power generated by the power generator fluctuates from a first generated power output to a second generated power output.

The computer-readable recording medium which records a control programs for causing one or more computers to perform the steps comprising: detecting regularly a power data that is the amount of electric power generated by the power generator; acquiring the power data from the detector; determining a first period based on the size of the fluctuations in the amount of electric power generated by the power generator from a first generated power output to a second generated power output; controlling the charge and discharge of the battery when the amount of electric power generated by the power generator does not return to within a specific range from the first generated power output during from an point in time to the first period, the point in time is time that the amount of electric power generated by the power generator fluctuates from a first generated power output to a second generated power output.

The device controlling a battery storing electric power generated by a power generator generating electric power using renewable energy, comprising: a controller configured to control the charge and discharge of the battery, wherein the controller is configured to acquire the power data from the detector, to determine a first period based on the size of the fluctuations in the amount of electric power generated by the power generator from a first generated power output to a second generated power output, to control the charge and discharge of the battery when the amount of electric power generated by the power generator does not return to within a specific range from the first generated power output during from an point in time to the first period, the point in time is time that the amount of electric power generated by the power generator fluctuates from a first generated power output to a second generated power output.

### Benefits of the Invention

By means of the present invention, after fluctuations are generated in the amount of power generated, if there is a return to a power output within a specific range of the first generated power output before fluctuation, charge and discharge control is not performed. The number of times the controller charges and discharges the power storage means can be reduced accordingly. By this means, a contrivance at lengthening the lifetime of the power storage means is enabled.

### BRIEF EXPLANATION OF THE FIGURES

FIG. 1 is a block diagram showing the configuration of the power generation system of the first embodiment of the invention.

FIG. 2 is a drawing in order to explain the trends in the power output on initiating the charge and discharge control of the power generation system and the target output value (An example where the charge and discharge control was initiated after an abrupt reduction in the power output) in the first embodiment shown in FIG. 1.

FIG. 3 is a drawing in order to explain the trends in the power output on initiating the charge and discharge control of the power generation system and the target output value (An example where the charge and discharge control was not initiated after an abrupt reduction in the power output) in the first embodiment shown in FIG. 1.

FIG. 4 is a drawing in order to explain the trends in the power output on initiating the charge and discharge control of the power generation system and the target output value (An example where the charge and discharge control was initiated after an abrupt increase in the power output) in the first embodiment shown in FIG. 1.

FIG. 5 is a drawing in order to explain the trends in the power output on initiating the charge and discharge control of the power generation system and the target output value (An example where the charge and discharge control was not initiated after an abrupt increase in the power output) in the first embodiment shown in FIG. 1.

FIG. 6 is a drawing in order to explain the relationship of the intensity of the load fluctuations output to the power grid and the fluctuation period.

FIG. 7 is a flow chart in order to explain the flow of the control of the power generation system in the first embodiment shown in FIG. 1.

FIG. 8 is a drawing in order to explain the sampling periods in the charge and discharge control.

FIG. 9 is a graph showing one example of the one day trend of the power output by the power generator.

FIG. 10 is a graph showing one example of the trends of the power output to the power grid when the power generator generates power with the trends as shown in FIG. 9 in the power generation system of the embodiment.

FIG. 11 is a graph showing one example of the trends of the power output to the power grid when the power generator generates power with the trends as shown in FIG. 9 in the power generation system of the comparative example.

FIG. 12 is a graph showing one example of the trends of the capacity of the battery cell when the power generator generates power with the trends as shown in FIG. 9 in the power generation system of the embodiment.

FIG. 13 is a graph showing one example of the trends of the capacity of the battery cell when the power generator generates power with the trends as shown in FIG. 9 in the power generation system of the comparative example.

### BEST MODE OF EMBODYING THE INVENTION

Hereafter the embodiments of the present invention are explained based on the figures.

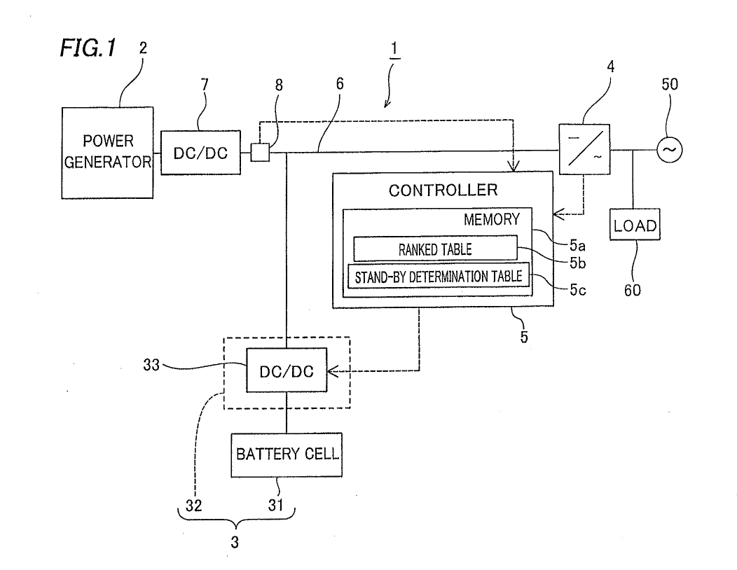

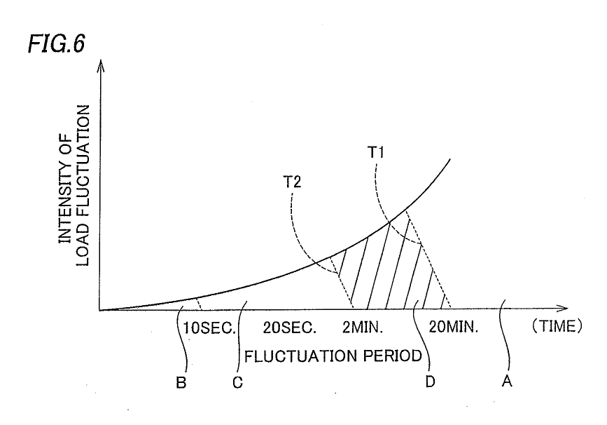

Firstly, the configuration of the power output system of the first embodiment of the invention (Solar power generation system 1) is explained while referring to FIG. 1˜FIG. 6. Now, this embodiment is an example to explain the adaptation of the ‘charge and discharge system’ of the invention to the charge and discharge system of the solar power generation system 1 provided with a power generator comprised of a solar cell.

The solar power generation system 1 provides the power generator 2 comprised of a solar cell which generates power using the light of the sun, and the battery 3 capable of the storage of the electrical power generated by the power generator 2, and a power output means 4, connected to the power grid 50, including an inverter outputting the power generated by the power generator 2 and the power stored by the battery 3, and a charge and discharge controller 5 controlling the charge and discharge of the battery 3. The load 60 is connected to the alternating current side of a bus 6 connected to the power grid 50 and the power output means 4.

There is a DC-DC converter 7 connected in series with the bus 6 to which the power generator 2 and the power output means 4 are connected. The DC-DC converter 7 has the function of converting the DC voltage of the power generated by the power generator 2 to a fixed DC voltage (Approximately 260 V in embodiment 1) and the output thereof to the power output means 4. Moreover, the DC-DC converter 7 has the so-called maximum power point tracking (MPPT) control functions. The function of MPPT is the function of the automatic adjustment of the operational voltage of the power generator 2 so as to maximize the power generated by the power generator 2. A diode (not shown in the figures) is provided between the power generator 2 and the DC-DC converter 7 so as to prevent the reverse flow of the electrical current flowing towards the power generator 2.

The battery 3 includes the battery cell 31, and the charge and discharge means 32, in order to charge and discharge the battery cell 31, which are connected in parallel to the bus 6. Secondary battery cells (for example, a lithium ion battery cell, or a Ni-MH battery cell, or the like) which have little natural discharge and high charge and discharge efficiency may be employed as the battery cell 31. The voltage of the battery cell 31 is approximately 48 V.

The charge and discharge means 32 has the DC-DC converter 33. The bus 6 and the battery cell 31 are connected via DC-DC converter 33. The DC-DC converter 33 is used on the occasion of the charging of the battery cell 31 to supply power from the bus 6 to the battery cell 31 by reducing the voltage of the power supplied to the battery cell 31 from the voltage of the bus 6 to a voltage suited to charging the battery cell 31. Moreover, on the occasion of the discharging, the DC-DC converter 33 discharges power from the battery cell 31 side to the bus 6 by raising the voltage of the power supplied to the bus 6 from the voltage of battery cell 31 to the vicinity of the voltage of the voltage of the bus 6.

The controller 5 performs the charge and discharge control of battery cell 31 by controlling the DC-DC convertor 33. Specifically, the controller 5 performs the discharge of battery cell 31 in a manner such as to compensate for the difference between the power generation by the power generator 2 and the target output value, based on the power generation by the power generator 2 (The output power of the DC-DC converter 7), and the later-described target output value. In other words, in the event that the power generation by the power generator 2 is greater than the target output value, the controller 5 controls the DC-DC converter 33 to charge the battery cell 31 with the excess power. On the other hand, in the event that the power generation by the power generator 2 is less than the target output value, the controller 5 controls the DC-DC converter 33 to discharge the battery cell 31 to make up for the shortfall in the electrical power.

The detector 8 which detects the power generation by the power generator 2 is provided on the output side of the DC-DC converter 7. The controller 5 can acquire power generation data for each specific detection time interval (e.g. less than 30 seconds), based on the output results of the detector 8 for the power output. The controller 5 acquires data on the power generation by the power generator 2 every 30 seconds. In this embodiment, the controller 5 acquires the power generation data of the power generator 2 every 30 seconds.

Because the fluctuation in the power generation cannot be detected accurately if this detection time interval of the amount of the power generation is too long or too short, there is a need to set an appropriate value in consideration of the period of the fluctuation of the amount of the power generation by the power generator 2. In this embodiment, the detection time interval is set to be shorter than the fluctuation period which can be responded to by means of the load frequency control (LFC).

The controller 5, recognizes the difference between the actual power output by the power output means 4 to the power grid 50, and target output value by acquiring the output power of the power output means 4. By this means, the controller 5 enables feedback control on the charging and discharging by the charge and discharge means 32 such that the power output from the power output means 4 becomes that of the target output value.

The controller 5 is configured in order to compute the target output value to the power grid 50 using the moving average method. The moving average method is a computation method for the target output value at a specific point in time based on the average value of the power output by the power generator 2 within a period prior to that point in time. The prior power generation data was successively recorded in memory 5a.

Hereafter, the periods in order to acquire the power output data used in the computation of the target output value are called the sampling periods. The sampling period is preferably a period between the lower limit period T2 and upper limit period T1 of the fluctuation period of the load in correspondence with the load frequency control (LFC), preferably greater than the lower limit period T1 and in the latter half (the longer period area) and should not be a period which is too long. As a specific example of the value for the sampling period, for example, they are periods of greater than 10 minutes and less than 30 minutes in respect of the power network having the characteristics of the “intensity of load fluctuation—the fluctuation period” shown in FIG. 6. In this embodiment the sampling period is set at approximately 20 minutes. In this situation, because the controller 5 acquires the power output data approximately every 30 seconds, the target output value is computed from the average value of 40 power output data samples in the last 20 minute period. There will be a detailed explanation provided below in respect of the upper limit period T1 and the lower limit period T2.

As described above, the solar power generation system 1 does not output the power output of the power generator 2, as is, to the power grid 50. The controller 5 computes the target output value from the power output by the power generator 2 in the past, and controls the charge and discharge of the battery cell 31 such that the total of the amount of the power output by the power generator 2, and the amount of the charge and discharge of the battery cell 31 equals the target output value. The solar power generation system 1 outputs the power of the target output value to the power grid 50. By performing this type of charge and discharge control, because the fluctuations in the power output to the power grid 50 are suppressed, the adverse impact on the power grid 50 of fluctuations in the power output by the power generator 2 due to the presence or absence of clouds are suppressed.

Here, the controller 5 is not configured to perform charge and discharge control all the time, but to only exert charge and discharge control when specific conditions are satisfied. In other words, the controller 5 does not exert charge and discharge control when the adverse effects on the power grid 50 of the output of the power output by the power generator 2 are small, and is configured to only exert charge and discharge control when the adverse effects would be great. Specifically, it is configured to perform the charge and discharge control when the fluctuation amount in the power output by the power generator 2 is greater than a specific fluctuation amount (hereafter referred to as “control initiating fluctuation amount”). As a specific value for the control initiating fluctuation amount, for example, it may be 5% of the rated power output of power generator 2. Moreover, the fluctuation amount in the power output is acquired by computing the difference in two sequential power output data by the power generator 2 as detected in the specific detection time intervals. Now, in relation to the specific number described above (5% of the rated power output of power generator 2), it is a numerical value which corresponds to the approximately 30 second detection time interval for the power output in this embodiment, and in the event that the detection time interval is modified, the control initiating fluctuation amount would need to be set in accordance with that detection time interval.

Even if the fluctuation amount in the power output by the power generator 2 is greater than the control initiating fluctuation amount, in the event that the generated power output returns to the vicinity of the pre-fluctuation power output within a specific stand-by time from the detection of an amount in excess of the control initiating fluctuation amount, the adverse impact on the power grid is small. In this type of situation, the controller 5 does not initiate charge and discharge control.

The specific stand-by time described above is a period which is less than the fluctuation period which the load frequency control (LFC) can deal with. On referring to the fluctuation period—load fluctuation relationship curve shown in FIG. 6, the specific stand-by time is a period preferably less than the upper limit period T1, and even more preferably a period of less than the lower limit period T2. In this embodiment, the specific stand-by time was set at approximately less than 2 minutes (for example, an integral multiple which is greater than twice the detection time interval).

The value in the vicinity of the pre-fluctuation power output is a value between the upper threshold value which is ever so slightly greater than the pre-fluctuation power output, and the lower threshold value which is ever so slightly smaller than the pre-fluctuation power output. The upper threshold value, for example, is a value which adds a value of 5% of the rated power output of power generator 2 to the pre-fluctuation power output. The lower threshold value, for example, is a value which reduces a value of 5% of the rated power output of the power generator 2 from the pre-fluctuation power output.

Moreover, in the event that the fluctuation amount in the power output is a decrease which is greater than the control initiation fluctuation amount, after the reduction in the power output, if there is a rise of the power output to greater than the lower threshold value within the stand-by period, the controller 5 reaches a determination that the power output returns to the vicinity of the pre-fluctuation power output.

Moreover, in the event that the fluctuation amount in the power output is an increase which is greater than the control initiation fluctuation amount, after the power output rises, if it drops to below the upper threshold value within the stand-by period, the controller 5 reaches a determination that the power output returns to the vicinity of the pre-fluctuation power output.

In this embodiment, the threshold value for the standard for determining a return to the vicinity of the power generation before the variation is different, when the variation amount in the power generation which is greater than the control initiating variation amount is an increase or a decrease.

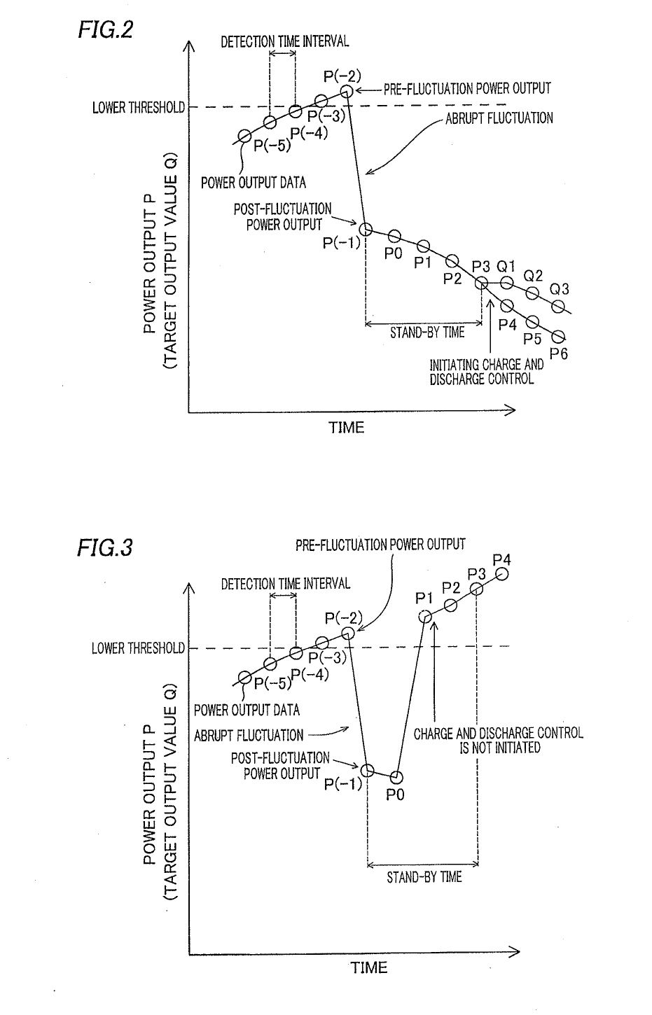

The point raised above is explained further while referring to FIG. 2˜FIG. 5. In the examples below the stand-by time is set at two minutes.

In the example shown in FIG. 2, when the power output is abruptly reduced from power output P (−2) to power output P (−1), the value does not return to the vicinity of the power output P (−2) value from the point when the power output P (−1) is detected within the stand-by period (does not rise). In this example, the detected power output P0˜P3 stays below the lower threshold for the duration of two minutes from the point in time when the power output P (−1) was detected. In this situation, the controller 5 reaches a determination that that the power output has not returned to the vicinity of the pre-fluctuation power output value (the power output P (−2)) within the stand-by time, and the charge and discharge control is initiated at the point in time when P3 is detected (The point in time when the stand-by time is terminated).

In the example shown in FIG. 3, after the power output P (−1) is detected, of the values detected for the power output in the two-minute stand-by time, while on the one hand the power output P0 is lower than the lower threshold value, the power output P1 has risen to greater than the lower threshold value. The controller 5 reaches a determination that that the power output has returned to the vicinity of the pre-fluctuation power output (the power output P (−2)) within the stand-by time, and the charge and discharge control is not initiated even when the stand-by time has elapsed.

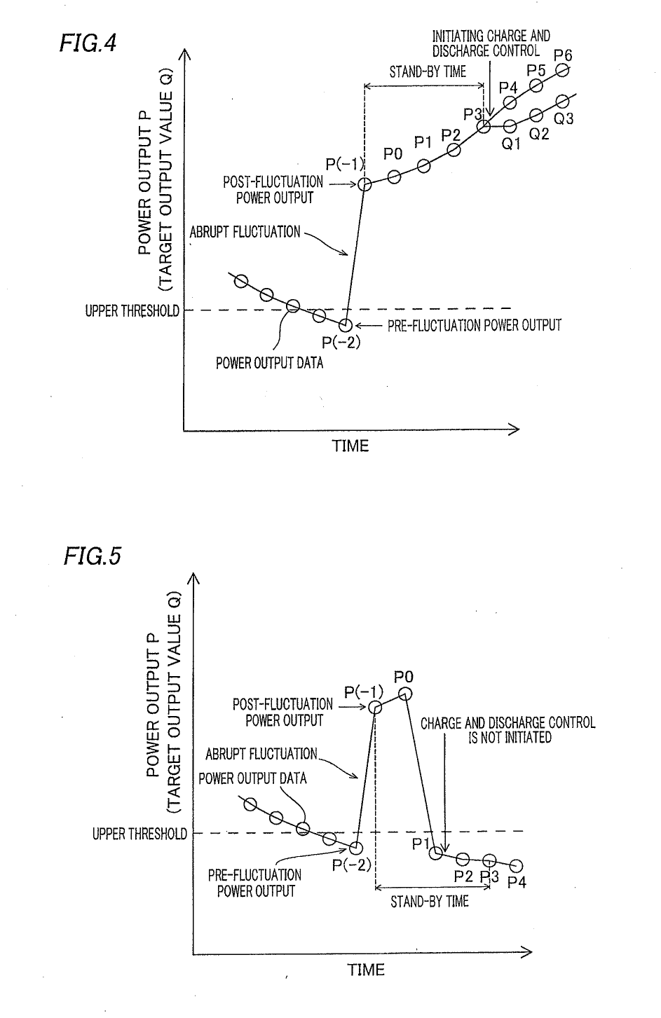

In the example shown in FIG. 4, when the power output is abruptly increased from power output P (−2) to power output P (−1), the value does not return to the vicinity of the power output P (−2) value from the point when the power output P (−1) is detected within the stand-by period (does not fall). In this example, the detected power output P0˜P3 stays above the upper threshold for the duration of two minutes from the point in time when the power output P (−1) was detected. In this situation, the controller 5 reaches a determination that the power output has not returned to the vicinity of the pre-fluctuation power output value (the power output P (−2)) within the stand-by time, and the charge and discharge control is initiated at the point in time when P3 is detected (The point in time when the stand-by time is terminated).

In the example shown in FIG. 5, after the power output P (−1) is detected, of the values detected for the power output in the two-minute stand-by time, while on the one hand the power output P0 is higher than the upper threshold value, the power output P1 has fallen to less than the upper threshold value. The controller 5 reaches a determination that that the power output has returned to the vicinity of the pre-fluctuation power output (the power output P (−2)) within the stand-by time, and the charge and discharge control is not initiated even when the stand-by time has elapsed.

Now, the pre-fluctuation power output P (−2) and the post-fluctuation power output P (−1) in FIG. 2˜FIG. 5 are each examples of example of the ‘first power output’ and the ‘second power output’ of the present invention.

As shown in FIG. 2 and FIG. 4, a big fluctuation is generated between the power generation P (−2) generated at a certain timing of the detection of the power output, and the power output P (−1) at the subsequent timing of the detection of the power generation, moreover, when the charge and discharge control is initiated on the recognition that the power output has not returned to the vicinity of the pre-fluctuation power output P (−2) within the stand-by period, the first target output value Q1 after the initiation of charge and discharge control is computed from the mean of the 40 power output data [samples] taken before P3 (P (−36), P (−35) . . . P0, P1, P2, P3). In the same manner, the second target output value Q2 after the initiation of charge and discharge control is computed from the mean of the 40 power output data [samples] taken before P4 (P (−35), P (−34), . . . P0, P1, P2, P3, P4).

Here, in the event that the power output fluctuates abruptly (5% of the rated power output of the power generator 2) the controller 5 determines the length of the stand-by period in accordance with the size of the fluctuation of the power output on each occasion. In other words, the smaller the fluctuation amount in the power output, the length of the stand-by period is determined to be longer, the controller 5 determines whether to initiate, or not, the charge and discharge control is made in the determined stand-by time. In this embodiment, the length of the stand-by time is selected from within a range of 0 seconds to two minutes (0 seconds, 30 seconds, 60 seconds or 120 seconds).

The length of the stand-by period is determined based on a pre-prepared ranked table 5b and the stand-by determination table 5c show in Table 1 and Table 2 below, based on the size of the fluctuation in the power output and the length of the detection time interval. The less the size of the fluctuation amount in the power output, the longer is the length of the stand-by time, in addition to the longer the detection time interval, the longer the stand-by time is determined to be. This ranked table 5b and the stand-by determination table 5c are each recorded in the memory 5a shown in FIG. 1. Memory 5a and the stand-by determination table 5c are each examples of the ‘recording means’ and the ‘first period determination table’ of the present invention.

As shown in Table 1, in the ranked table 5b, plural categories of ranks are assigned in size order in accordance with the size of the fluctuation in the power output. In this embodiment, there are four applicable ranks: The fluctuation level A (highest rank), B (second rank), C (third rank) and D (lowest rank). The fluctuation level ranks A˜D are assigned based on the absolute value for the fluctuation amount in the power output computed from the difference in the power output data samples before and after (The size of the fluctuation in the power output), and the length of the detection time interval of the power output data. The absolute value of the fluctuation amount is categorized into four levels fluctuation amount range categories. Specifically, when the absolute value of the fluctuation amount is greater than 40% of the rated power output of the power generator 2, a fluctuation amount category is the highest rank. When the absolute value of the fluctuation amount is greater than 20% and less than 40% of the rated power output, a fluctuation amount category is the second rank. When the absolute value of the fluctuation amount is greater than 10% and less than 20% of the rated power output, a fluctuation amount category is the third rank. When the absolute value of the fluctuation amount is greater than 5% and less than 10% of the rated power output, a fluctuation amount category is the fourth and smallest rank. Moreover, the detection time interval is categorized into three specific ranges of time intervals, with less than 5 seconds as the shortest range (time interval category), and greater than 5 seconds and less than 15 seconds as the second shortest category (time interval category), and greater than 15 seconds as the longest shortest category (time interval category). Moreover, as shown in Table 2, A, B, C and D can be 0 seconds (no stand-by time), detection time interval×1, detection time interval×2, detection time interval×4, respectively, and in this embodiment A, B, C and D become 0 seconds, 30 seconds, 60 seconds and 120 second, respectively. Moreover, in respect of Table 1, the shorter the detection time interval, the shorter the stand-by time set. This is because when, if the fluctuation amount detected for the power output is the same, the shorter the detection time interval, the greater the size of the fluctuation and the impact of the power output to the power grid 50 is greater.

TABLE 1
Ranked Table 5b

| | Size of the fluctuation | | | |
|---|---|---|---|---|
| | Greater than | Greater than | Greater than | |
| | 5% and less | 10% and less | 20% and less | |
| | than 10% of | than 20% of | than 40% of | Greater than |
| | the rated | the rated | the rated | 40% of the |
| | output of | output of | output of | rated output |
| Detection | the power | the power | the power | of the power |
| Time interval | generator | generator | generator | generator |
| Less than | B | A | A | A |
| 5 seconds | | | | |
| Greater than | C | B | B | A |
| 5 seconds | | | | |
| and less than | | | | |
| 15 seconds | | | | |
| Greater than | D | C | B | A |
| 15 seconds | | | | |

TABLE 2
Stand-by time determination table 5c

| | A | B | C | D |
|---|---|---|---|---|
| Stand-by | 0 | Detection | Detection | Detection |
| time (sec) | | time in- | time in- | time in- |
| | | terval × 1 | terval × 2 | terval × 4 |

Moreover, the controller 5, after initiating the charge and discharge control, in the event that a there is a state where fixed time elapses when the fluctuation amount in the power output is low (a state of less than the control initiating fluctuation amount (5% of the rated power output)), terminates the charge and discharge control. Specifically, when 20 minutes elapses where the fluctuation amount in the power output of the power generator 2 is in a state where it is less than 3% of the rated power output, it terminates the charge and discharge control.

Next, an explanation is provided of the fluctuation period ranges of the main fluctuation controls performed by the charge and discharge control of this embodiment. As shown in FIG. 6, the control methods which can be used are different depending on the periods of the fluctuation periods. The domain D (The domain shown shaded) represents a fluctuation period where the load can be dealt with by the load frequency control. The domain A shows a fluctuation period where the load can be dealt with by the EDC. The domain B is a domain where the effects of the load fluctuation can be naturally absorbed by the endogenous control of the power grid 50. Moreover, the domain C is a domain which can be dealt with by the governor free operation of the generators in each power generating location. Here, the border line between domain D and domain A corresponds to the upper limit period T1 of the fluctuation periods of the loads which can be dealt with by the load frequency control and the border line between domain C and domain D corresponds to the lower limit period T2 of the fluctuation periods of the loads which can be dealt with by the load frequency control. This upper limit period T1 and the lower limit period T2, are not characteristic periods of FIG. 6, and can be understood to be numerical values fluctuating with the intensity of the load fluctuations. The duration of the fluctuation period drawn fluctuates with the configuration of the power network. In this embodiment, looking at the load fluctuation which have the fluctuation periods (fluctuation frequencies) are included in the range of the domain D (a domain which LFC can deal with) but which governor free operation or endogenous control of the power grid 50 and EDC cannot deal with, the objective is enable to suppress the load fluctuation.

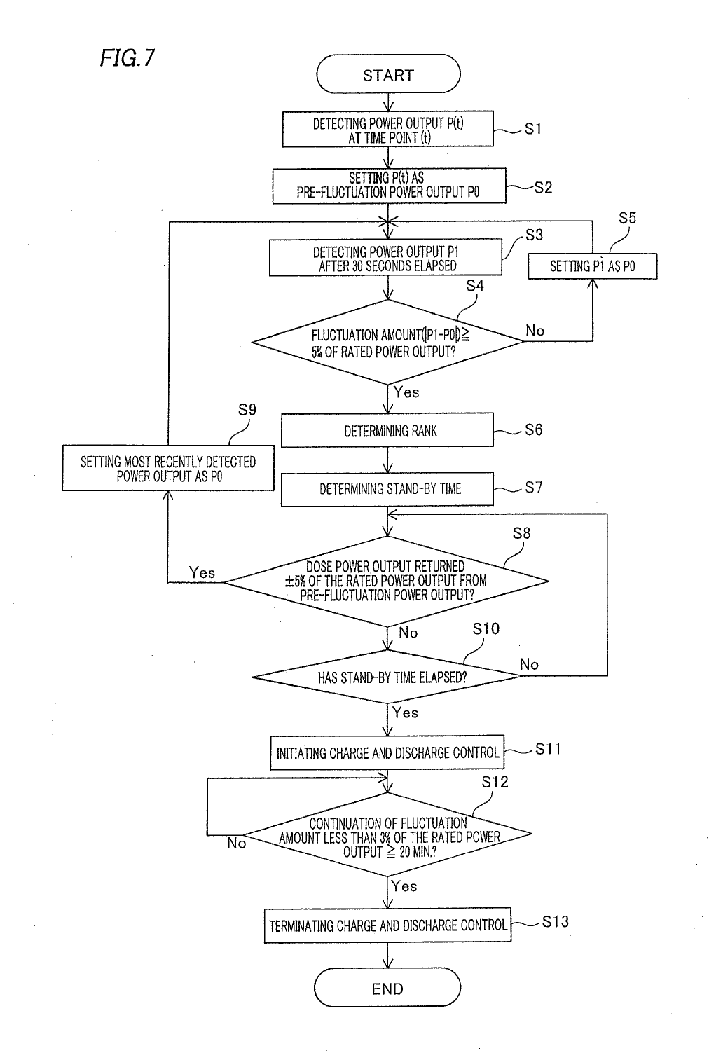

Next, an explanation is provided of the flow of control of the solar power generation system 1 while referring to FIG. 7.

Firstly in Step S1, the controller 5 detects the power generation P(t) of the power generator 2 in respect of a time t.

In Step S2, the controller 5 designates the power output P(t) as the pre-fluctuation power output P0.

Then, in Step S3, the controller 5 detects the power output after 30 seconds has elapsed from time t and designates this as detected value P1.

Thereafter in Step S4, the controller 5 makes a determination as to whether the fluctuation amount in the power output (|P1-P0|) is greater than 5% of the rated power output of power generator 2. In the event that the fluctuation amount in the power output is not greater than 5% of the rated power output of power generator 2, then in Step S5 the [value of] P1 is designated that of P0, and the value of P1 in Step S3 is acquired [once more], and the fluctuation in the power output is monitored.

In the event that the fluctuation amount of the power output is greater than 5% of the rated power output of power generator 2, in Step S6, the controller 5 determines the rank (Refer to FIG. 1 and Table 1) of the fluctuation level based on ranks in Table 5b. For example if the absolute value of the fluctuation amount in the power output (|P1-P0|) is 25% of the rated power output of the power generator 2, the absolute value of the fluctuation amount is included in the second range (>20% and <40%). Moreover, as the detection time interval in this embodiment is 30 seconds, the rank of the fluctuation level is determined to be B.

Then, in Step S7, the controller 5 determines the stand-by time based on Table 5c (Refer to FIG. 1 and Table 2). As the rank was B in the example above, the stand-by time is determined to be the detection time interval×1=30 seconds. Then, the count of the determined stand-by time is started.

Thereafter in Steps S8 and S9, the controller 5 makes a determination as to whether the power output has returned a range of ±5% of the rated power output from the pre-fluctuation power output P0 within the stand-by time determined in Step S7, or not. In other words, in the event that the power output was reduced (P0>P1), after the detection of P1 and within the stand-by time, the controller 5 determines whether the detected power output exceeds the lower threshold or not (the value which reduces the value of 5% of the rated power output from the power output P0). If the detected power output exceeds the lower threshold, the controller 5 reaches a determination that the power output has returned to the vicinity of the pre-fluctuation power output P0. In the same manner, in the event that the power output is increased (P0<P1), after the detection of P1 and within the stand-by time, the controller 5 determines whether the detected power output is less than the upper threshold or not (the value which adds the value of 5% of the rated power output to the power output P0). If the detected power output less than the upper threshold, the controller 5 reaches a determination that the power output has returned to the vicinity of the pre-fluctuation power output P0.

In the event that there was a return of the power output to the vicinity of the pre-fluctuation level (a range of ±5% of the rated power output from the pre-fluctuation power output P0) within the stand-by time determined in S7, because the impact on the power grid 50 would be small, the controller 5 moves on to step S9 without initiating the charge and discharge control. Then in Step S9, not only is the most recently detected power output designated the P0, in returning to Step S3, the fluctuations in the power output are monitored.

Moreover, in the event that the power output did not return to the vicinity of the pre-fluctuation power output within the stand-by time, the controller 5 initiates the charge and discharge control in Step S11. In other words, with the target output value as the mean of the power output in the previous 20 minutes, the controller 5 controls the charge and discharge of the battery cell 31 in order that this target output value should be output by the power output means 4.

Moreover, in step S12, the controller 5 determines if, in the conduct of the charge and discharge control, a state where the fluctuation amount in the power output was small (a state where the fluctuation amount in the power output was less than 3% of the rated power output of power generator 2) continued for more than 20 minutes. The controller 5 continues the charge and discharge control until a state where the fluctuation amount in the power output is small is reached for 20 minutes.

When the charge and discharge control is being performed and when a state where the fluctuation amount in the power output is small is reached for 20 minutes, the charge and discharge control is terminated. Normally, because the downward fluctuation amount in the power output when the incident sunlight level falls continues to fall, the charge and discharge control is terminated when the amount of incident sunlight falls.

In this embodiment, as described above, as the size of the fluctuation amount of the power output of the power generator 2 declines, not only is the length of the stand-by time made longer. In the event that the power output does not return to the vicinity of the pre-fluctuation power output after the point where a fluctuation occurred within the stand-by time, the controller 5 performs the control of the charge and discharge of the battery 3. In the event that the power output does return to the vicinity of the pre-fluctuation power output, after the point where a fluctuation occurred, because the controller 5 does not perform the charge and discharge control of the battery 3, a reduction in the number of times the battery 3 is charged and discharged is enabled. By this means, a contrivance at lengthening the lifetime of the battery 3 is enabled.

Moreover, in this embodiment, as described above, in the event that the power output does not return to within a specific range from the pre-fluctuation power output after the point where a fluctuation occurred, the controller 5 performs the control of the charge and discharge promptly by shortening the stand-by time when the fluctuation in the power output is great (Occasions when the impact on the power grid 50 would be great). When the fluctuations of the power generation are small (Occasions when the impact on the power grid 50 would be small), the stand-by time is set to long, the controller 5 enables a longer period of time when charge and discharge control is not performed. By this means, the controller 5, while enabling charge and discharge control when the impact on the power grid 50 would be great, charge and discharge control is not performed when the impact on the power grid 50 is small. By this means, the alleviation of the effects on the power grid 50 is enabled and the number of instances of charge and discharge of the battery 3 can be reduced. By this means, a contrivance at lengthening the lifetime of the battery 3 is enabled.

Moreover, in this embodiment, as described above, when the controller 5 determines the stand-by time when the fluctuation amount of the power output by the power generator 2 exceeds the control initiating fluctuation amount. Moreover, when the power output does not return to the vicinity of the pre-fluctuation power output within the stand-by time, the controller 5 performs charge and discharge control. By enabling this type of configuration, when the fluctuation amount of the power output is less than the control initiating fluctuation amount, because charge and discharge control is not performed, a reduction in the number of times the battery 3 is charged and discharged is enabled. By this means, a contrivance at lengthening the lifetime of the battery 3 is enabled.

Furthermore, in this embodiment, as described above, the controller 5 determines the stand-by time based on not only the size of the fluctuation amount of the power output, but also the detection time interval. By enabling this type of configuration, by taking the detection time interval into consideration, the determination of the length of the stand-by time in accordance with the degree of impact on the power grid 50 is enabled.

Moreover, in this embodiment, as described above, the controller 5 sets the standby-time to be shorter, the shorter the period of the detection time interval is set. In this situation, even when the fluctuation amount of the power output is the same, the shorter the detection time interval, the actual fluctuation in the power output acquired in that detection time interval is greater, and because the impact on the power grid 50 would be great, by making the stand-by time shorter as the detection time interval is gets shorter, a stand-by time can be determined whose length is in accordance with the degree of impact on the power grid 50.

Furthermore, in this embodiment, as described above, by setting the detection time interval at a period less than the lower limit period of the fluctuation periods which the load frequency control can deal with, and by detecting the fluctuation in the power output based on the thus acquired detected power output, the fluctuations in the power output having fluctuation periods which the load frequency control can deal with can be more easily detected. By this means, the performance of the charge and discharge control is enabled whereby fluctuation components of the fluctuation periods which the load frequency control can deal with are reduced.

Moreover, in this embodiment, as described above, by setting the stand-by time at a period less than the lower limit period of the fluctuation periods which the load frequency control can deal with, and by not performing charge and discharge control from the point when the power output fluctuates until the stand-by time [has elapsed], the fluctuation components in the generated fluctuation period can be controlled to be at least within the range of the fluctuation periods which the load frequency control can deal with. For this reason, while suppressing the fluctuations of the fluctuation period components which the load frequency control can deal with, the effective reduction of the number of instances of the charge and discharge of the battery 3 can be reduced.

Furthermore, in this embodiment, as described above, by setting the sampling period at a period less than the lower limit period of the fluctuation periods which the load frequency control can deal with, and by controlling the charge and discharge control such that the power of the target output value computed based on the power output data of such a sampling period is outputted to the power grid, in particular, the components of the fluctuation periods which the load frequency control can deal with can be reduced. By this means, the suppression of the impact on the power grid 50 is enabled.

Moreover, in this embodiment, as described above, in performing charge and discharge control and when a state where the fluctuation amount in the power output by the power generator 2 is small is reached for a specific continuous period (20 minutes), the charge and discharge control is terminated. By means of this type of configuration, in a state where the fluctuation amount in the power output is small (a state where the impact on the power grid 50 is small), because charge and discharge control can be terminated, a reduction in the number of times the battery 3 is charged and discharged is enabled. By this means, a contrivance at lengthening the lifetime of the battery 3 is enabled.

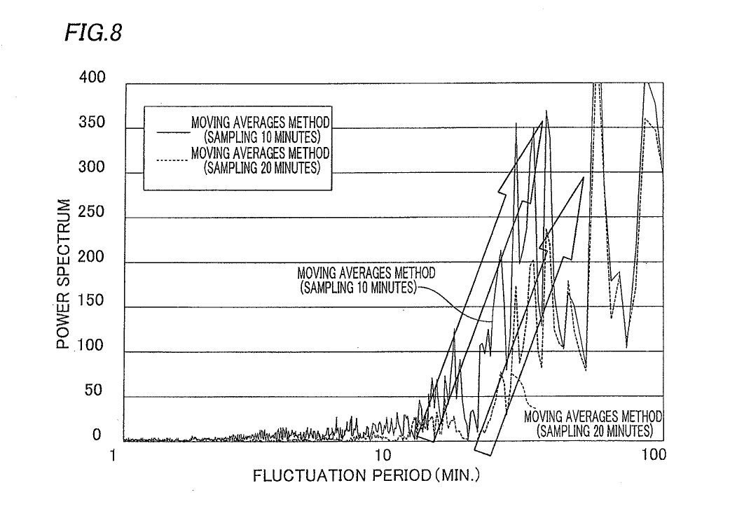

Next, the sampling period of the moving average method are considered. Here, the results of the FFT analysis of the power output data when the sampling period which is the acquisition period of the power output data was 10 minutes, and the results of the FFT analysis of the power output data when the sampling period was 20 minutes are shown in FIG. 8. From FIG. 8 it can be appreciated that when the sampling period was 10 minutes, while the fluctuations in respect of a range of up to 10 minutes of a fluctuation period could be suppressed, the fluctuations in a range of fluctuation periods which were greater than 10 minutes were not suppressed well. Moreover, when the sampling period was 20 minutes, while the fluctuations in respect of a range of up to 20 minutes of a fluctuation period could be suppressed, the fluctuations in a range of fluctuation periods which were greater than 20 minutes was not suppressed well. Therefore, it can be understood that there is a good mutual relationship between the size of the sampling period, and the fluctuation period which can be suppressed by the charge and discharge control. For this reason, it can be said that by setting the sampling period, the range of the fluctuation period which can be controlled effectively changes. In that respect, in order to suppress parts of the fluctuation period which can be addressed by the load frequency control which is the main focus of this system, it can be appreciated that in order that sampling periods which are greater than the variation period corresponding to what the load frequency control can deal be set, in particular, it is preferable that they be set from the vicinity of the latter half of T1˜T2 (The vicinity of longer periods) to periods with a range greater than T1. For example, in the example in FIG. 6, by utilizing a sampling period of greater than 20 minutes, it can be appreciated that suppression of most of the fluctuation periods corresponding to the load frequency control is enabled. However, when the sampling period is lengthened, there is a tendency for the required battery cell capacity to become greater, and it is preferable to select a sampling period which is not much longer than T1.

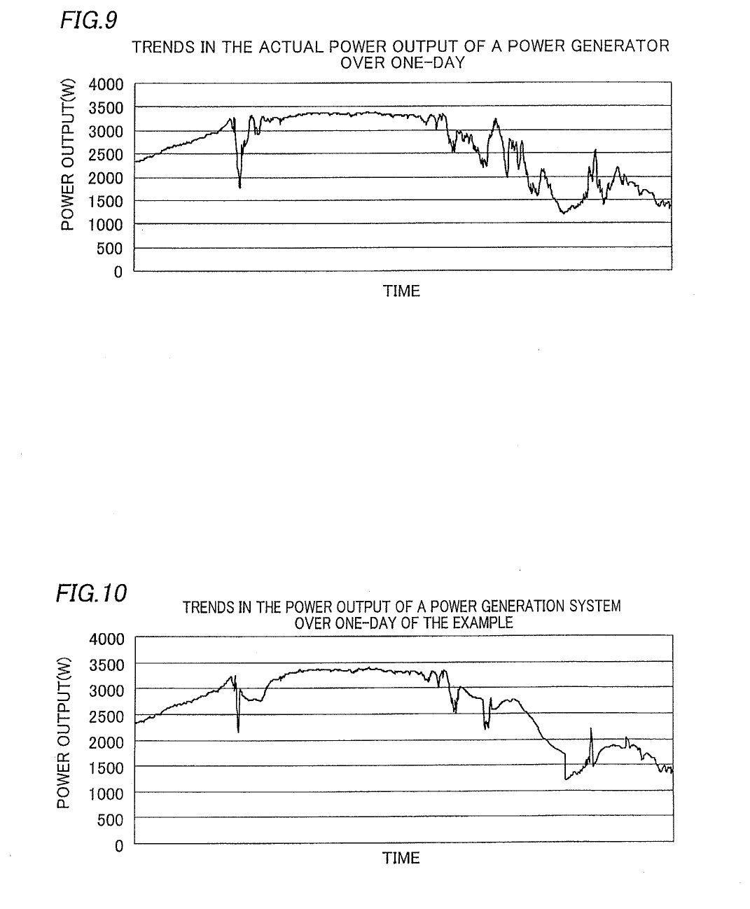

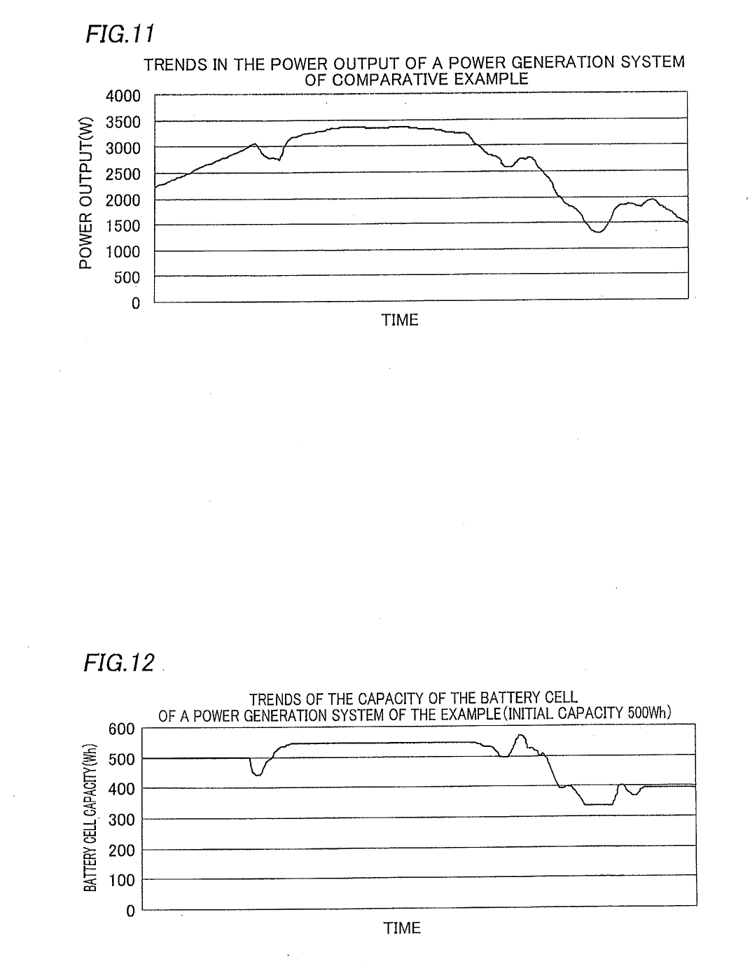

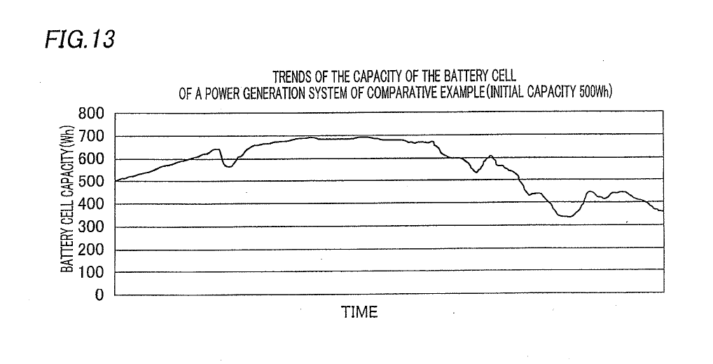

Next, the simulation results proving the effectiveness of the performance of the charge and discharge control of the present invention are explained while referring to FIG. 9˜FIG. 13. In FIG. 9, the trends in the power output over one day of a power generator with a rated power output of 4 kW (Example 1) are shown. In FIG. 10, in the power generation system of this embodiment, the results of an example of a simulation are shown of the power output to the power grid when the power output trend of the power generator is as shown in FIG. 9, and in FIG. 11 a comparative example of a power system, the results of a simulation are shown of the power output to the power grid when the power output trend of the power generator is as shown in FIG. 9. Now in the example, the configuration of the initiation and the termination of the charge and discharge control were as described in the embodiment above. Moreover, in FIG. 12 a comparison is shown of the trends of the battery cell capacity corresponding to the example of the power generation system of FIG. 10, and in FIG. 13 is that of the power generation system of the comparative example shown in FIG. 11.

As shown in FIG. 9˜FIG. 11, in both the example and the comparative example, it can be appreciated that smoothing of the fluctuations in the power output of the power generator as shown in FIG. 9 was enabled. As shown in FIG. 10, while there was fluctuation in the power output of the power generator in the example remaining when compared with the comparative example, that remaining fluctuation was mainly in the fluctuation period of less than two minutes (a fluctuation period which is less than the lower limit period of the fluctuation periods which load frequency control can deal with), and is a fluctuation period which the governor free operation of the power generators of generating stations can deal with. In other words, in the power generation system of the example, the fluctuation in the power output were suppressed in the fluctuation periods which the load frequency control can deal with.

Moreover, as shown in FIG. 13, whereas the capacity of the battery cell in the power generation system of the comparative example fluctuated all the time, in the power system of the example, the capacity of the batter cell was greater for a fixed period. In other words, it can be appreciated that, in comparison with the comparative example, the number of charge and discharge times of the battery cell in the example was greatly reduced. Moreover, in this simulation, while the total charged and discharged capacity during one day in the example was approximately 670 kW, in the comparison example the total of the charged and discharged capacity was approximately 1190 kW. In other words, it can be appreciated that the charged and discharged capacity in the example can be reduced when compared to the comparative example.

Now the embodiments and examples disclosed here should be considered for the purposes of illustration in respect of all of their points and not limiting embodiments. The scope of the present invention is represented by the scope of the patent claims and not the embodiments described above, in addition to including all other modifications which have an equivalent meaning and fall within the scope of the patent claims.

For example, in the embodiment described above, an embodiment where solar cells were employed as the power generator 2, but this invention is not limited to this, and other natural energy power generators such as wind power generators may be employed.

Moreover, in the embodiment described above, lithium ion batteries or Ni-MH batteries were employed as the battery cell, but this invention is not limited to these, and may employ other secondary batteries.

Moreover, in the embodiment described above, an explanation was provided of an embodiment where the voltage of the battery cell 31 was 48V, but this invention is not limited to this, and voltages other than 48 V may be employed. Now the voltage of the battery cell is preferably below 60V.

Furthermore, in the embodiment described above, the control initiating fluctuation amount was set at 5% of the rated power output of the power generator 2, but this invention is not limited to these, and numerical values other than those above may be employed. For example, the control initiating fluctuation amount can be set at standard of the pre-fluctuation power output.

Moreover, in the embodiment described above, an example where the stand-by time was less than two minutes was explained, but this invention is not limited to this, and it may be more than two minutes. Now the stand-by period is a period preferably less than the upper limit period T1 of the fluctuation period which the LFC can deal with, and even more preferably a period of less than the lower limit period T2 of the fluctuation period. However, the lower limit period may vary due to the so-called run-in period effect of the power grid. Moreover, the size of the run-in period effect may vary due to the degree of installation of solar cell systems and their regional distribution.

Furthermore, in the embodiment described above, the upper threshold value and the lower threshold value in order to reach a determination as to whether there was a return to the vicinity of pre-fluctuation power output, respectively, are a value which adds a value of 5% of the rated power output to the pre-fluctuation power output, and a value which reduces a value of 5% of the rated power output from the pre-fluctuation power output, but the present invention is not limited to these. Values other than theses may be employed as the upper threshold value and the lower threshold value. Moreover, without varying the upper threshold value and the lower threshold value, the same value may be employed. For example, a power output which is the same as before the fluctuation may be employed as the common threshold value for the upper and lower side.

Furthermore, in the embodiment above, an explanation was provided whereby the power consumption in the consumer home was not taken into consideration in the load in the consumer home, but this invention is not limited to this. In the computation of the target output value, a power is detected wherein at least part of the load is consumed at the consumer home, and the computation of the target output value may be performed considering that load consumed power output or the fluctuation in the load consumed power output.

Moreover, in regard to the sampling periods and in regard to the specific values of the bus voltages and the like described in the embodiment, they are not limited to these in this invention, and may be modified appropriately.

Moreover, in the embodiment described above, an example was described wherein the charge and discharge control was performed when the fluctuation in the power output was in excess of the control initiating fluctuation amount, and when the stand-by time had elapsed, but this invention is not limited to this, and may be configured to initiate the charge and discharge control without providing a threshold value for the initiation of the charge and discharge control (The control initiating fluctuation amount), by making a determination as to whether the power output returned to the pre-fluctuation level for every fluctuation within the stand-by time, and initiating the charge and discharge control when there was no return.

Furthermore, in the embodiment described above, ranking was applied to the fluctuated level of the power output, and the length of the stand-by time was determined in accordance with rank of the fluctuation level, such that in the example the length of the stand-by time was varied in stages (In the embodiment, a maximum of four levels A˜D), but this invention is not limited to this, and the stand-by time may be divided into a multiple of more stage lengths, such that a continuity of stand-by times may be set in accordance with the fluctuation amount of the power output.

Moreover, in the embodiment described above, an example was described where on the fluctuation amount of the power output remaining small (Less than 3% of the rated power output) for 20 minutes, the charge and discharge control was terminated, but this invention is not limited to this, and after the initiation of the charge and discharge control, it may be terminated after a fixed time, or may be terminated based on the size of the power output or the time. Moreover, a different value than 3% of the rated power output may be set, and this threshold value may be greater than the control initiating fluctuation amount.

Furthermore, in the embodiment described above, an example was described wherein the charge and discharge control was performed when the power output did not return to the vicinity of the pre-fluctuation level (±5% of the rated power output in respect of the pre-fluctuation power output), but this invention is not limited to this, and the charge and discharge control may be initiated in the event that there is no return to a range which is much wider in respect of the vicinity of the pre-fluctuation power output (a specific range in respect of the pre-fluctuation power output).

Moreover, in the embodiment described above, an example was described wherein the fluctuation amount of the power output was detected by the difference between the power output as detected by the detector 8, but this invention is not limited to this, and the detection of a power which reflects the power output may suffice. For example, the fluctuation amount in the power output may be detected by taking the difference in the amount sold (The power which reduces the consumed power of the load 60 from the power output of the power generator 2).

Furthermore, in the embodiment described above, an explanation was provided of a configuration wherein the controller 5 controls the DC-DC convertor 33 in order to perform the charge and discharge control of the battery cell 31, but the present invention is not limited to this. For example, by the provision of a switch for the charge and discharge means 32 to perform the charge and discharge control of the battery cell 31, and the control of the charge and discharge of battery cell 31 may be configured by the controller 5 performing the control of the ON/OFF of the switch.

What is claimed is:

1. An electric power generation system comprising:
a power generator configured to generate electric power using renewable energy;
a battery configured to store electric power generated by the power generator;
a detector configured to detect power data that is an amount of electric power generated by the power generator;
a power output unit configured to output electric power generated by the power generator and electric power discharged by the battery; and
a controller configured to control charge and discharge of the battery,
wherein the controller is configured to acquire the power data from the detector, to set a first period based on a change of the power data from a first detected power data to a second detected power data, and to perform the charge and discharge of the battery when the power data does not return to a predetermined range measured from the first detected power data within a predetermined period from a detection of the second power data.

2. The system of claim 1, wherein the first period is set longer when the change of the power data is smaller.

3. The system of claim 2, wherein the controller is further configured to acquire the power data from the detector at predetermined time intervals, to compute the change of the power data based for each time interval and to determine whether the change of the power data is greater than a first predetermined amount.

4. The system of claim 2, wherein the controller is further configured to acquire the power data from the detector at predetermined time intervals, and the first period is set based on both the change of the power data and a length of the predetermined intervals.

5. The system of claim 4, wherein the first period is also set longer when the length of the predetermined intervals is longer.

6. A method of controlling a battery storing electric power generated by a power generator generating electric power using renewable energy, the method comprising:
detecting power data that is an amount of electric power generated by the power generator;
acquiring the power data from the detector;
determining a first period based on the size of the fluctuations in the amount of electric power generated by the power generator from a first generated power output to a second generated power output;
setting a first period based on a change of the power data from a first detected power data to a second detected power data; and
performing charge and discharge of the battery when the power data does not return to a predetermined range measured from the first detected power data within a predetermined period from a detection of the second power data.

7. A computer-readable recording medium which records a control programs for causing one or more computers to perform a process comprising the steps of:
detecting power data that is an amount of electric power generated by the power generator;
acquiring the power data from the detector;
determining a first period based on the size of the fluctuations in the amount of electric power generated by the power generator from a first generated power output to a second generated power output;
setting a first period based on a change of the power data from a first detected power data to a second detected power data; and
performing charge and discharge of the battery when the power data does not return to a predetermined range measured from the first detected power data within a predetermined period from a detection of the second power data.

8. A device controlling a battery storing electric power generated by a power generator generating electric power using renewable energy, comprising:
a controller configured to control charge and discharge of the battery; and
a receiving unit configured to receive from the power generator power data that is an amount of electric power generated by the power generator;
wherein the controller is configured to set a first period based on a change of the power data from a first received power data to a second received power data, and to perform the charge and discharge of the battery when the power data does not return to a predetermined range measured from the first received power data within a predetermined period from a reception of the second power data.
